(19) United States
(12) Patent Application Publication
(10) Pub. No.: US 2008/0179399 A1
(43) Pub. Date: Jul. 31, 2008

(54) METHOD OF CONFIRMING ELECTORAL VOTE

(75) Inventor: George Phillips, Paso Robles, CA (US)

Correspondence Address: Vista IP Law Group LLP, 2040 MAIN STREET, 9TH FLOOR, IRVINE, CA, 92614, US

(73) Assignee: VERIFY FIRST TECHNOLOGIES, INC., Paso Robles, CA (US)

(21) Appl. No.: 12/014,733

(22) Filed: Jan. 15, 2008

Related U.S. Application Data
(60) Provisional application No. 60/884,988, filed on Jan. 15, 2007.

(51) Int. Cl. G07C 13/00

(52) U.S. Cl. 235/386

(57) ABSTRACT

A method of verifying a ballot tabulation comprises storing a plurality of different codes respectively corresponding to a plurality of ballots, storing electoral voting information in association with each of the different codes, receiving request to verify that one of the ballots has been tabulated and a code corresponding to the one ballot, recalling the stored electoral voting information corresponding to the received code, and transmitting a tabulation verification of the ballot corresponding to the received code based on the recalled electoral voting information. A method of voting comprises casting an electoral ballot, obtaining a receipt of the cast electoral ballot, acquiring a code from the receipt, electronically transmitting a request to verify tabulation of ballot along with the code, and receiving a tabulation verification of the ballot in response to transmitting the request.

### RELATED APPLICATION

This application claims the benefit of priority to U.S. Provisional Application Ser. No. 60/884,988, filed Jan. 15, 2007, which is expressly incorporated herein by reference.

### FIELD OF THE INVENTION

The present invention relates to voting systems, and more particularly, to voting systems that allow a voter to confirm that a vote has been counted.

### BACKGROUND OF THE INVENTION

The American voting public has begun to lose faith and confidence in our electoral systems. While the electoral process has always had some degree of credibility issues, the 2000 Presidential Election between Al Gore and George Bush, Jr. exploded the issue into a national crisis. The perception of an increasingly flawed system has plagued every election since that time. National issues and political division in America has fueled increased voter turnout and close elections that have increased voter scrutiny of the electoral process.

In response to the inherent problems associated paper voting systems, such votomatic punch cards, which were at the center of the 2000 Presidential Election crisis, the use of electronic voting machines in the electoral process has increased. Rather than resolving the issue of the lack of voter confidence in the electoral process, however, the introduction of electronic voting machines has, in many cases, increased the potential for voter fraud.

One type of electronic voting machine is a direct-recording electronic (DRE) voting machine, which processes voting data using software and directly stores the processes voting data with memory, and is thus, a paperless system. Because there is no audit mechanism other than the software that tabulated the results to begin with, DRE machines are open to undetectable errors and malicious software attacks. Thus, there is no reliable means for verifying vote tallies in DRE machines.

In some jurisdictions (e.g., New Hampshire), paper ballots are required by law, and thus, the use of DRE machines is not appropriate in these jurisdictions. In a series of preliminary security reports issued by the National Institute of Standards and Technology (NIST), the federal agency is recommending significant changes to standards for electronic voting machines. If the recommendations are approved, the 2007 version of the Voluntary Voting Systems Guideline (VVSG) would bar DRE voting machines from future elections. The reports also recommend focusing attention on improving the reliability and usability of voting systems that produce verified paper records, emphasizing that a voting system “should never be able to record an electronic record and at the same time fail in properly creating or storing the paper record.”

In addition, many voters still feel more comfortable using paper as a voting medium. For example, even if all votes are recorded electronically, some voters may fear that it is easier to electronically alter an electronic ballot than a paper ballot. Also, print media is easier to read than electronic media (e.g., on computer screens). Consequently, although such DRE systems are currently being used in some jurisdictions, such conventional DRE systems may not gain widespread acceptance.

Ultimately, the best solution for the foregoing problems is to provide a way for voters to confirm, with confidence, that their vote was counted, and therefore counts.

### SUMMARY OF THE INVENTION

In accordance with a first aspect of the present inventions, a method of verifying a ballot tabulation is provided. The method comprises storing a plurality of different codes (e.g., numeric codes) respectively corresponding to a plurality of ballots, and storing electoral voting information in association with each of the different codes. The electoral voting information may comprise ballot tabulation data indicating whether the respective one of the ballots has been tabulated. One method further comprises receiving at least one request to generate codes, generating the plurality of different codes in response to the at least one request, and transmitting the plurality of different codes. Such method may further comprise receiving at least a portion of the electoral voting information along with the request to generate codes.

The method further comprises receiving request to verify that one of the ballots has been tabulated and a code corresponding to the one ballot (e.g., from a voter), recalling the stored electoral voting information corresponding to the received code, and transmitting a tabulation verification of the ballot corresponding to the received code (e.g., to the voter) based on the recalled electoral voting information. An optional method comprises transmitting the recalled electoral voting information along with the tabulation verification. Such electoral voting information can include, e.g., one or more of the election title, polling location, election date, ballot tabulation date/time, and ballot recount date/time. In one method, the different codes are non-sequential, so that ballot cannot be traced back to the voter. The codes can be maintained in both a human-readable format and a machine-readable format to provide the ability for both manual entry and scanned entry of the code.

In accordance with a second aspect of the present invention, a method of marking a plurality of election ballots is provided. Each ballot has a body portion and a stub portion that is detachable from the body to serve as a receipt. The method comprises obtaining a plurality of non-sequential codes (e.g., numeric codes), and respectively marking the ballots with the non-sequential codes, wherein a code is placed on both the body portion and the stub portion of each respective ballot. The ballot may be respectively marked with the non-sequential codes in a human-readable format and/or a machine-readable format. Because the codes are non-sequential, a voter may subsequently use the code to obtain voting information specific to the ballot cast by the voter without having the ballot traced back to the voter.

In accordance with a third aspect of the present inventions, a method of voting is provided. The method comprises casting an electoral ballot (e.g., a paper ballot), obtaining a receipt (e.g., a paper receipt) of the cast electoral ballot, and acquiring a code (e.g., a numeric code) from the receipt. The code may be obtained, e.g., by manually reading the code from the receipt and/or optically scanning the code from the receipt. The method further comprises electronically transmitting the code (e.g., using a consumer device), and receiving a tabulation verification of the ballot in response to transmitting the code. The request may, e.g., be transmitted to a computer server and the tabulation verification may, e.g., be received from the computer server. The method may further comprise obtaining electoral voting information (e.g., one or more of the election title, polling location, election date, ballot tabulation date/time, and ballot recount date/time) in response to transmitting the code.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is an electoral voting system arranged in accordance with one embodiment of the present inventions;

FIG. 2 is an embodiment of a paper ballot that is generated by the electoral voting system of FIG. 1;

FIG. 3 is an exemplary display window that can be used to enter a code obtained from the paper ballot of FIG. 2 into a consumer device of the electoral voting system in order to verify that the ballot has been tabulated;

FIG. 4 is an exemplary display window that can be used to view a verification that the ballot of FIG. 2 has been tabulated;

FIG. 5 is an exemplary display window that can be used to view a verification that the ballot of FIG. 2 has not been tabulated; and

FIG. 6 is a flow diagram of one method of operating the electoral voting system of FIG. 1 to verify that a ballot has been tabulated.

### DETAILED DESCRIPTION OF THE EMBODIMENTS

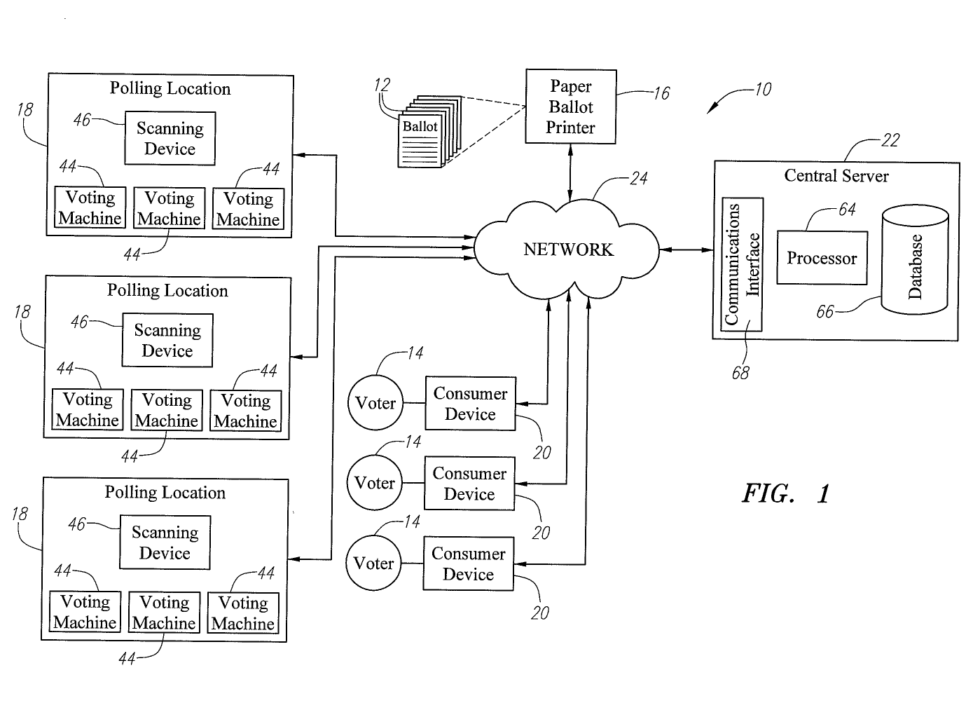

Referring first to FIG. 1, an electoral voting system 10 arranged in accordance with one embodiment of the present inventions will now be described. The system 10 is capable of generating paper ballots 12 that carry codes that can be entered into the system 10 by the voters 14 after casting the ballots 12 to verify whether or not the ballots 12 have been tabulated. To this end, the system 10 generally comprises a paper ballot printer 16, a plurality of polling locations 18, a plurality of consumer devices 20, a central server 22, and a network 24 through which the printer 16, polling locations 18, and consumer devices 20 communicate with the central server 22.

The network 24 may be an open network, such as the internet, or a private network, such as an intranet. In one embodiment, communication to and from the central server 22 may be accomplished by means of a secure communications protocol, such as secure sockets layer (SSL) or transport layer security (TLS).

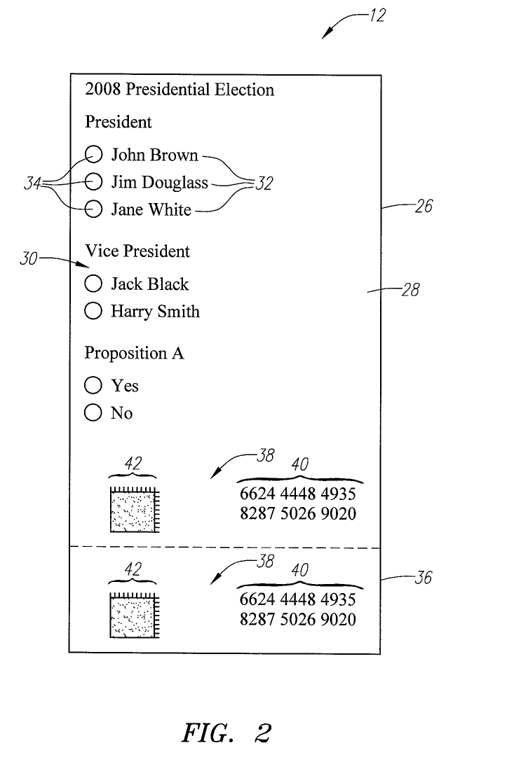

The paper ballot printer 16 takes the form of any entity that is capable of manufacturing ballots 12. For example, the paper ballot printer 16 may be operated by the jurisdiction that is conducting the election or may be an independent ballot printer 16 contracted by such jurisdiction. As shown in FIG. 2, the ballot 12 is conventional in that it comprises a tangible substrate 26 (e.g., paper) that includes a body portion 28, and conventional voting information 30 printed on the body portion 28. Preferably, the ballot 12 is capable of being tabulated by optical scanning means. To this end, the voting information 30 includes candidates and/or propositions 32 and corresponding marking spaces 34 that can be filled in with a pencil or pen by a voter to select the candidates and/or propositions. Alternatively, the ballot 12 may take the form of a punch card, in which case, voting information, such as the candidates and/or propositions are not printed on the body portion of the ballot, but rather are shown on a machine in which the ballot is inserted. In whatever form the ballot 12 takes, it is unconventional in that includes a stub portion 36 that can be removed from the body portion 28 as a receipt (e.g., by providing perforations within the substrate 26), and a duplicative code 38 printed on both the stub portion 36 and the body portion 28 of the ballot 12.

The code 38 is printed on the ballot 12 in both a human-readable format 40 and a machine-readable format 42. In the illustrated embodiment, the human-readable format 40 of the code 38 is numeric code consisting of a string of twenty-four numbers that can be read by a human. By utilizing different combinations of the twenty-four numeric characters, virtually an indefinite amount of security codes can be used. It should be appreciated, however, that the code 38 can be more or less than twenty-four numeric characters in length, and may alternatively be an alphanumeric code, use only letters, or use all of the ASCII characters. The machine-readable format 42 of the code 38 takes the form of a graphic symbol that can be read by a machine. In the illustrated embodiment, the machine-readable format 42 of the code 38 takes the form of a datamatrix, which is a two-dimensional barcode consisting of black and white squares arranged in a rectangular pattern. It should be appreciated that the machine-readable format 42 of the code 38 may take the form of other graphical symbols, such as barcode fonts consistent with the PDF417 or QR bar code standards.

As will be described in further detail below, the paper ballot printer 16 obtains a batch of codes 38 from the central server 22 via the network 24 in response to transmitting a request to the central server 22 via the network 24, and may optionally supply electoral voting information (e.g., an election title and/or election date) to the central server 22 via the network 24 that can be associated with the codes 38. The electoral voting information may be submitted with or separate from the request for codes 38. The request for codes 38 and/or the electoral voting information may be transmitted from the paper ballot printer 16 to the central server 22 in a conventional manner, such as, e.g., a web interface.

Preferably, the codes 38 in the batch are non-sequential, not predictable, and non-repeating, so that absolute anonymity and privacy of the voter is ensured. Thus, each ballot 12 includes a unique and random code 38. The paper ballots 12 printed by the paper ballot printer 16 may be supplied to the polling locations 18 in a conventional manner, e.g., standard shipping. Alternatively, the paper ballots 12 can be supplied to the voters 14 outside of the polling locations 18; for example, directly to the voters' residences in the case of absentee voting and vote-by-mail elections.

The polling locations 18 may be maintained by any entity or entities that are in the business of conducting elections. Each polling location 18 includes a plurality of voting machines 44. In the illustrated embodiment, the voting machines 44 are paper voting machines, e.g., optical scan voting machines. In these cases, the voters 14 mark their choice at the polling location 18 (or in the case of absentee voting or vote-by-mail elections, in the privacy of their own home), usually by filling a rectangle, circle, or oval, or completing an arrow. During tabulation, the optical scan voting machine 44 interprets the votes using “dark mark logic”, whereby the machine 44 selects the darkest mark within a given set as the correct choice or vote. Alternatively, the voting machine 44 can take the form of a punch card voting machine. In this case, the voter 14 punches holes in the card (with a supplied punch device) opposite their candidate or ballot issue choice. After voting, the voter 14 may place the ballot 12 in a ballot box, or the ballot may be fed into a computer vote tabulating device at the polling location 18.

Alternatively, the ballots 12 are tabulated at a central location (not shown) located remotely from the polling locations 18. If an optical scan voting machine is used, it will be located at the central location, in which case, the polling location 18 merely serves as a means for collecting the ballots 12. If a punch card voting machine is used, the ballots 12 will simply be transported to the central location for tabulation after the ballots 12 have been punched by the voters 14 at the respective polling locations 18.

Significantly, each polling location 18 includes an optical scanning device 46, which may be associated with the voting machines 44 or may be separate from the voting machines 44. The optical scanning device 46 may be, e.g., a barcode reader capable of reading the machine-readable code 38 located on the body portion 28 of each ballot 12. The optical scanning device 46, after reading the codes 38 from the ballots 12, is configured for transmitting electoral voting information specific to the ballots 12 to the central server 22 via the network 24. Such electoral voting information may include the polling location, ballot tabulation date/time, and ballot recount date/time. To the extent that it has not already been transmitted to the central server 22 by the ballot printer 16, the electoral voting information transmitted by the polling location 18 to the central server 22 may also include the election title and election date.

Significantly, the transmission of the electoral voting information to the central server 22 allows any voter to verify with his or her vote has been cast and tabulated. In particular, after casting the ballot 12, each voter 14 may detach the stub portion 36 (as a receipt) from the body portion 28 of the respective ballot 12, obtain the code 38 from the stub portion 36, and subsequently enter the code 38 carried by the stub portion 36 into one of the consumer devices 20.

The consumer device 20 may be any suitable device capable of capturing the code 38 from the stub portion 36 of the ballot 26, transmitting the code 38 to the central server 22 over the network 24, receiving a ballot tabulation verification response (and optionally additional electoral voting information) from the central server 22 over the network 24, and conveying the response to the voter 14 in possession of the consumer device 20. By way of non-limiting example, the consumer device 20 may be a mobile phone, PDA, notebook, desktop computer.

The code 38 may be captured by the consumer device 20 using any one of a variety of data entry methods, including keyed entry from a keyboard or telephone keypad, a camera, and/or a barcode reader. In the case of a keyed entry, the voter 36 may simply read the human-readable format 40 of the code 38 from the stub portion 36 of the ballot 26. In the case of a camera or barcode reader, the machine-readable format 42 of the code 38 can be optically scanned from the sub portion 36 of the ballot 26.

The code 38 and verification response can be transmitted between the consumer device 20 and the central server 22 via the network 24 using any of a variety of network transmission methods, including electronic mail, text messaging, telephonically, webpage access, etc. The consumer device 20 may convey the ballot tabulation verification response to the voter 14 using any one of a variety of methods, e.g., visually or audibly.

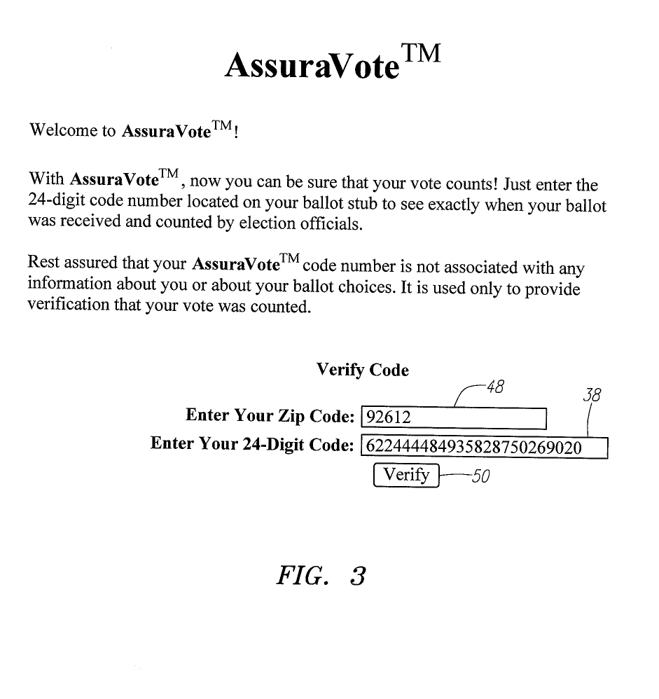

In one exemplary embodiment, a request to verify that a ballot 12 has been tabulated can be made through the display screen of a web interface illustrated in FIG. 3. In this case, a zip code 48 of the voter 14 and the code 38 obtained from the stub portion 36 of the ballot 12 can be entered into the display screen. The display screen has a verify button 50 that, when clicked, transmits the request from the consumer device 20 to the central server 22 over the network 24.

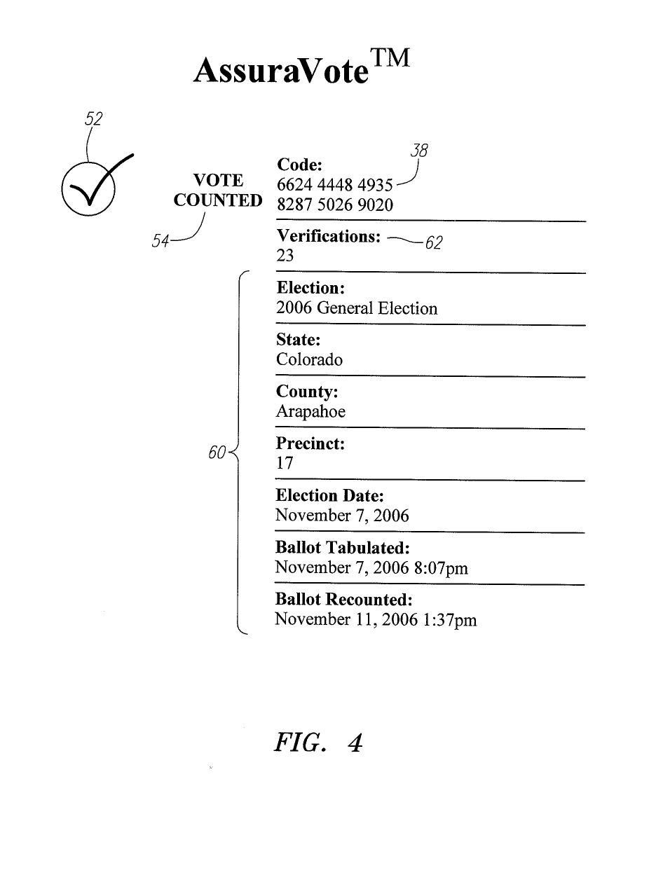

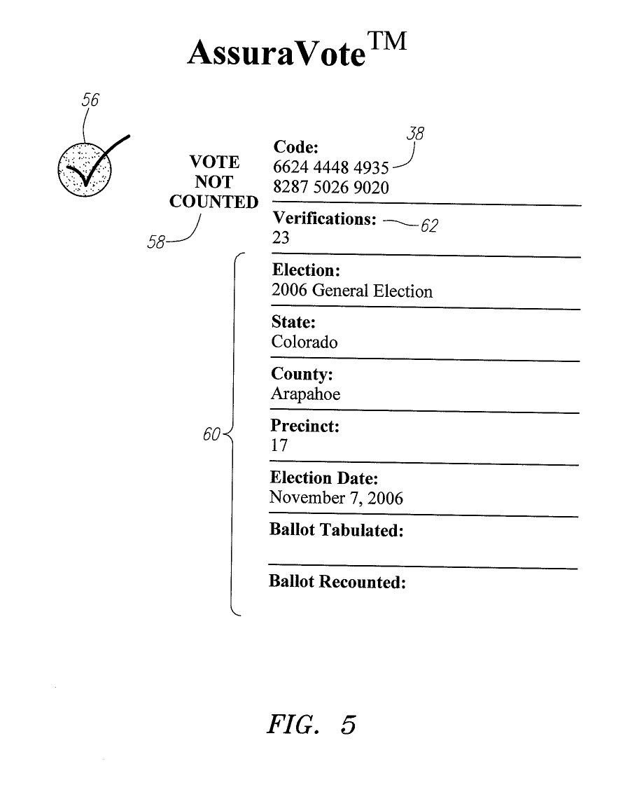

In one exemplary embodiment, the ballot tabulation verification response can be displayed using the display screen of a web interface illustrated in FIGS. 4 and 5. In particular, if the ballot 12 corresponding to the entered code 38 has been tabulated, the consumer device 20 will display a graphical check mark 52 and the text “VOTE COUNTED” 54 if the response from the central server 22 indicates that the ballot 12 has been tabulated, as shown in FIG. 4, and will display a graphical circle with no check mark 56 and the text “VOTE NOT COUNTED” 58 if the response from the central server 22 indicates that the ballot 12 has not been tabulated, as shown in FIG. 5.

Any additional electoral voting information 60 can be displayed on the display screen of FIGS. 4 and 5 as well. For example, as shown in FIG. 4, the election title “2006 General Election,” polling location” (and in particular, the polling state “Colorado,” polling county “Arapahoe,” and polling precinct “17”), election date “Nov. 7, 2006,” ballot tabulation date/time “Nov. 7, 2006, 8:07 pm,” and ballot recount date/time “Nov. 11, 2006, 1:37 pm” are displayed on the consumer device 20 for visualization by the voter 14. The same information is shown in FIG. 5, with the exception that ballot tabulation date/time and ballot recount date/time is left blank, which reflects that the ballot 12 has neither been tabulated nor recounted. The consumer device 20 may also receive and display the code 38 and the number of times the corresponding ballot 12 has been verified 62, as illustrated in FIGS. 4 and 5.

Referring back to FIG. 1, the central server 22 may be operated by an entity that offers ballot coding and verification services to one or more jurisdictions. The central server 22 may take the form of a server computer, a client computer, a personal computer (PC), or any other device capable of executing computer software. While only a single server is illustrated, several servers that are networked together may be used.

The central server 22 generally comprises a processor 64 (e.g., a central processing unit (CPU)), a database 66, and a communications interface 68. The central server 22 may also comprise memory (not shown) in which software may be stored and executed by the processor 64 for performing the code generation and ballot verification functions described herein. The communications interface 68 can be any networking device, such as a modem, that allows the processor 64 to communicate with the ballot printer 16 and consumer devices 20 over the network 24.

As briefly discussed above, the central server 22 is configured for receiving a request from the ballot printer 16 to generate a batch of codes 38 respectively corresponding to the ballots 12 previously or subsequently produced by the ballot printer 16, and for generating the codes 38 in response to this request. The batch of codes 38 are stored and maintained in the database 66 and transmitted over the network 24 to the ballot printer 16. As discussed above, the batch of codes 38 are preferably non-sequential and are provided to the ballot printer 16 in both a human-readable format and a machine readable format. The central server 22 is also configured for receiving electoral voting information specific to each of the ballots 12 from the ballot printer 16 (to the extent that the ballot printer 16 possesses such electoral voting information) and associating the electoral voting information with each of the different codes 38. As discussed above, the electoral voting information can be transmitted from the ballot printer 16 and/or polling locations 18 to the central server 22.

The central server 22 is configured for receiving a request for verifying that a ballot 12 has been tabulated from the consumer device 20, and for retrieving the electoral voting information corresponding to the security code contained within the request. Based on the retrieved electoral voting information, the central server 22 is also configured for transmitting data indicating whether the ballot 12 corresponding to the code 38 has been tabulated to the consumer device 20. That is, if the retrieved electoral voting information indicates that the ballot 12 has been tabulated, the data transmitted to the consumer device 20 will indicate that the ballot 12 has been tabulated. If the retrieved electoral voting information indicates that the ballot 12 has not been tabulated, the data transmitted to the consumer device 20 will indicate that the ballot 12 has not been tabulated. The central server 22 is also configured for optionally transmitting the retrieved electoral voting information to the consumer device 20.

It should be appreciated that the system 10, as illustrated in FIG. 1, is functional in nature, and that some of the functions performed by one component in the system 10 can instead be performed in another component of the system 10, and some of the components may be eliminated all together, while some components can be added to the system 10. For example, one or both of the code generation and ballot verification functions of the central server 22 can be performed at the polling locations 18. In this case, the central server 22 may be eliminated, and the ballot printer 16 can communicate with the polling locations 18 to obtain the batch of codes 38, and the consumer devices 20 can communicate with the polling stations 18 to verify the tabulation of the respective ballots 12. As another example, the ballot printer 16 may be incorporated into the polling locations 18 or in a central location away from the polling locations 18 where the ballots 12 are tabulated. In this case, a single computer can be used to obtain codes 38 from the central server 22 and transmit all electoral voting information to the central server 22. As still another example, the ballot printer 16 and/or the ballot tabulation functions can be performed at the central server 22. In this case, the code generation, ballot printing, and ballot verification functions can all be performed internally at a single location.

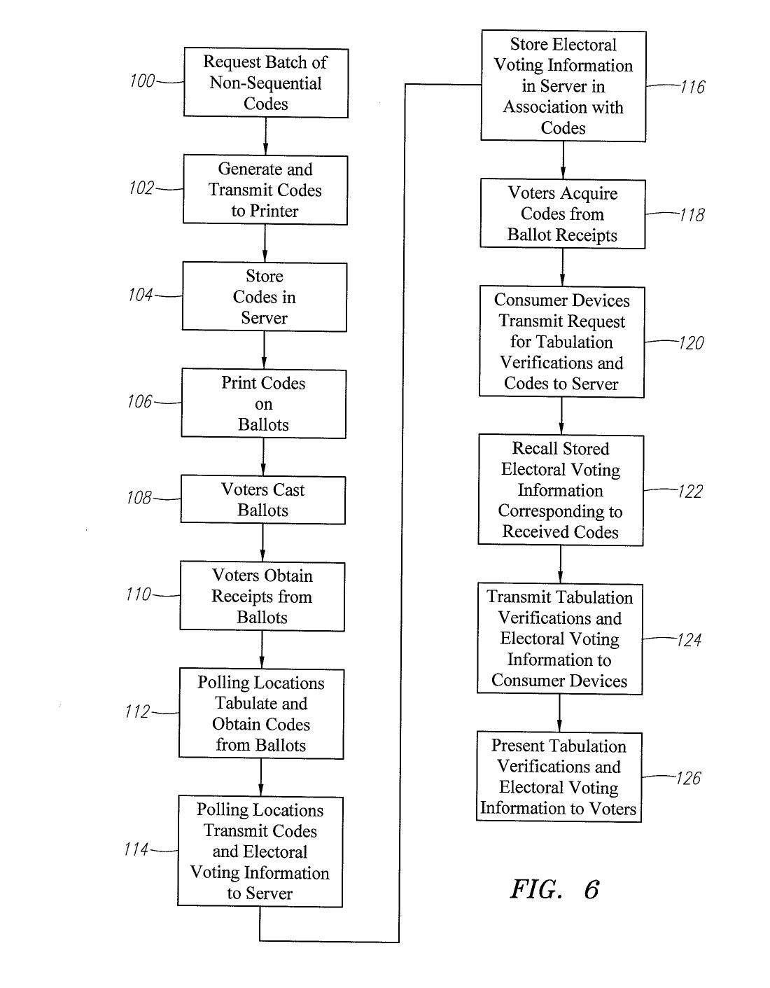

Having described the structure and function of the system 10, its operation will now be described with reference to FIGS. 1 and 6. First, a request to generate a batch of non-sequential codes 38 respectively corresponding to the ballots 12 is transmitted from the ballot printer 16 to the central server 22 over the network 24 (step 100). The request may optionally include at least a portion of the electoral voting information (e.g., the election title and election date). In response to the request, the central server 22 generates and transmits the batch of codes 38 to the ballot printer 16 over the network 24 (step 102). The central server 22 stores the batch of codes 38 along with any electoral voting information associated with the codes 38 (step 104).

Next, the ballot printer 16 respectively marks the ballots 12 with the codes 38 by printing the codes 38 on both the body portion 28 and stub portion 36 of the ballots 12 and in both a human-readable format 40 of the machine-readable format 42 (shown in FIG. 2) (step 106). Then, each voter 14, after obtaining the ballots 12 either at the local polling locations 18 or his or her home, cast a respective ballot 12 either at the local polling locations 18 or by mail (step 108), and obtains a receipt of the cast ballot 12 by detaching the stub portion 36 from the body portion 28 of the ballot 12 (step 110). Next, the polling locations 18 (or a central polling location) tabulates the cast ballots 12 and obtains the codes 38 from the body portions 28 of the ballots 12 (e.g., by optically scanning the machine-readable format 42 of the codes 38)(step 112), and transmits the codes 28 along with the electoral voting information specific to the ballots 12 (e.g., the polling location and ballot tabulation date/time, and if not already transmitted the election title and election date) to the central server 22 over the network 24)(step 114). If the ballots 12 are subsequently recounted, the codes 28 along with the recount date/time can be subsequently transmitted to the central server 22 over the network 24. Using the codes 38 transmitted with the electoral voting information, the central server 22 then stores the electoral voting information (including the ballot tabulation date/time) in association with the already stored respective codes 38 (step 116).

The voter 14 then acquires the code 38 from the receipt (stub portion 36); for example, by visually reading the code 38 from the receipt and manually entering it into the consumer device 20 in possession of the voter 14 or optically scanning the code 38 from the receipt using the consumer device 20 (step 118). Next, a request to verify that the ballot 12 has been tabulated and the code 38 is electronically transmitted from the consumer device 20 to the central server 22 over the network 24 (step 120).

Next, after receiving the request to verify that the ballot 12 has been tabulated and the corresponding code 38, the central server 22 recalls the stored electoral voting information corresponding to the received code 38 (step 122), and transmits a tabulation verification of the ballot corresponding to the received code 38, along with the electoral voting information, to the consumer device 20 over the network 24 (step 124). That is, if the recalled electoral voting information indicates that the ballot 12 has been tabulated, the transmitted tabulation verification will indicate that the ballot 12 has indeed been tabulated, and if the ballot 12 has not been tabulated, the transmitted tabulation verification will indicated that the ballot 12 has not yet been tabulated. The consumer device 20 will then visually or aurally present the tabulation verification, along with the additional electoral vote information, to the voter 14 (step 126).

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A method of verifying a ballot tabulation, comprising:
storing a plurality of different codes respectively corresponding to a plurality of ballots;
storing electoral voting information in association with each of the different codes;
receiving request to verify that one of the ballots has been tabulated and a code corresponding to the one ballot;
recalling the stored electoral voting information corresponding to the received code; and
transmitting a tabulation verification of the ballot corresponding to the received code based on the recalled electoral voting information.

2. The method of claim 1, wherein the received code is received from a voter, and the tabulation verification is transmitted to the voter.

3. The method of claim 1, wherein the stored electoral voting information comprises ballot tabulation data indicating whether the respective one of the ballots has been tabulated.

4. The method of claim 1, further comprising transmitting the recalled electoral voting information along with the tabulation verification.

5. The method of claim 4, wherein the electoral voting information comprises one or more of the election title, polling location, election date, ballot tabulation date/time, and ballot recount date/time.

6. The method of claim 1, further comprising:
receiving at least one request to generate codes; and
generating the plurality of different codes in response to the at least one request; and
transmitting the plurality of different codes.

7. The method of claim 6, further comprising receiving at least a portion of the electoral voting information along with the request to generate codes.

8. The method of claim 1, wherein the different codes are non-sequential.

9. The method of claim 1, wherein each of the codes is numeric code.

10. The method of claim 1, wherein each of the codes is stored in both a human-readable format and a machine-readable format.

11. A method of marking a plurality of election ballots, each ballot having a body portion and a stub portion that is detachable from the body portion to serve as a receipt, comprising:
obtaining a plurality of non-sequential codes; and
respectively marking the ballots with the non-sequential codes, wherein a code is placed on both the body portion and the stub portion of each respective ballot.

12. The method of claim 11, wherein each of the codes is a numeric code.

13. The method of claim 11, wherein the ballots are respectively marked with the non-sequential codes in a human-readable format.

14. The method of claim 11, wherein the ballots are respectively marked with the non-sequential codes in a machine-readable format.

15. The method of claim 11, wherein the ballots are respectively marked with the non-sequential codes in both a human-readable format and a machine-readable format.

16. A method of voting, comprising:
casting an electoral ballot;
obtaining a receipt of the cast electoral ballot;
acquiring a code from the receipt;
electronically transmitting a request to verify tabulation of ballot along with the code; and
receiving a tabulation verification of the ballot in response to transmitting the request.

17. The method of claim 16, wherein the ballot is a paper ballot.

18. The method of claim 16, wherein the receipt is a paper receipt.

19. The method of claim 16, further comprising obtaining electoral voting information with the tabulation verification in response to transmitting the response.

20. The method of claim 19, wherein the electoral voting information comprises one or more of the election title, polling location, election date, ballot tabulation date/time, and ballot recount date/time.

21. The method of claim 16, wherein the code is a numeric code.

22. The method of claim 16, wherein the code is acquired by manually reading the code from the receipt.

23. The method of claim 16, wherein the code is acquired by optically scanning the code from the receipt.

24. The method of claim 16, wherein the code is electronically transmitted from a consumer device.

25. The method of claim 16, wherein the request is transmitted to a computer server and the tabulation verification is received from the computer server.
